(19) United States
(12) Patent Application Publication
(10) Pub. No.: US 2020/0241140 A1
(43) Pub. Date: Jul. 30, 2020

(54) APPARATUS AND METHOD

(71) Applicant: Sony Semiconductor Solutions Corporation, Kanagawa (JP)

(72) Inventors: Maarten Kuijk, Antwerpen (BE); Daniel Van Nieuwenhove, Hofstade (BE); Ward Van Der Tempel, Muizen (BE)

(73) Assignee: Sony Semiconductor Solutions Corporation, Kanagawa (JP)

(21) Appl. No.: 16/649,410

(22) PCT Filed: Sep. 27, 2018
(86) PCT No.: PCT/EP2018/076363

§ 371 Date: Mar. 20, 2020

(30) Foreign Application Priority Data
Sep. 28, 2017 (EP) 17193694.1

(51) Int. Cl. G01S 17/42; G01S 17/48; G01S 17/931

(52) U.S. Cl. CPC G01S 17/42; G01S 17/931; G01S 17/48

(57) ABSTRACT

An apparatus has a light emitting unit which emits a sheet of light for illuminating an object, and a detection source which estimates first position information of the object, based on time of flight detection of light reflected by the object, and detects light reflected by the object for determining second position information of the object, wherein the second position information of the object is determined based on triangulation, and wherein the triangulation is based on the estimated first position information.

### TECHNICAL FIELD

The present disclosure generally pertains to an apparatus and a method in the field of determining position information of objects.

### TECHNICAL BACKGROUND

Generally, an apparatus is known which has a detection source for detecting a distance of an object, based on, for example, using a laser beam emitted to an object and capturing the reflected light with a camera.

Moreover, it is known that, the distance between the detection source and the laser, and their tilt angles, should be fixed and constant during measurements, in order to estimate a distance between the detection source or laser and the object.

However, it has been recognized that the distance between the detection source and the laser may change, for example, due to ambient temperature which may change the length of structural elements between the detection source and the laser, which may decrease a measurement accuracy, e.g. of an estimated distance, estimated angle, etc.

Moreover, in devices, where a detection source and a laser are installed next to each other on a plate, such as a sturdy piece of metal, although, there might be a fixed distance between them, the reflection of the light emitted by the laser may not be in the field of view of the detection source (e.g. due to the short distance to the object).

Although, there exist techniques for detecting objects and estimating their position information, it is generally desirable to improve apparatuses and methods for detecting objects and determining their position information.

### SUMMARY

According to a first aspect, the disclosure provides an apparatus including a light emitting unit configured to emit a sheet of light for illuminating an object, and a detection source, configured to estimate first position information of the object, based on time of flight detection of light reflected by the object; and detect light reflected by the object for determining second position information of the object, wherein the second position information of the object is determined based on triangulation, and wherein the triangulation is based on the estimated first position information.

According to a second aspect, the disclosure provides a method including emitting a sheet of light for illuminating an object, estimating first position information of the object; and detecting light reflected by the object for determining second position information of the object, wherein the second position information of the object is determined based on triangulation, and wherein the triangulation is based on the estimated first position information.

Further aspects are set forth in the dependent claims, the drawings and the following description.

### BRIEF DESCRIPTION OF THE DRAWINGS

Embodiments are explained by way of example with respect to the accompanying drawings, in which:

FIGS. 1(a) and 1(b) schematically illustrate an embodiment of an apparatus;

FIG. 2 schematically illustrates an embodiment of an apparatus for detecting an object having regular surfaces, and determining its position information;

FIG. 3 schematically illustrates an embodiment of an apparatus for detecting an object having irregular surfaces, and determining its position information;

FIG. 4 schematically illustrates a first embodiment of an apparatus which is incorporated in a vehicle;

FIG. 5 schematically illustrates a second embodiment of an apparatus which is incorporated in a vehicle;

FIG. 6 schematically illustrates a third embodiment of an apparatus which is incorporated in a vehicle;

FIG. 7 schematically illustrates an embodiment of an apparatus including a circuitry for detecting an object and determining its position information;

FIG. 8 is a flowchart of an embodiment of a method for detecting an object and determining its position information; and

FIG. 9 is a flowchart of an embodiment of a method for detecting an object and determining its 3D shape.

### DETAILED DESCRIPTION OF EMBODIMENTS

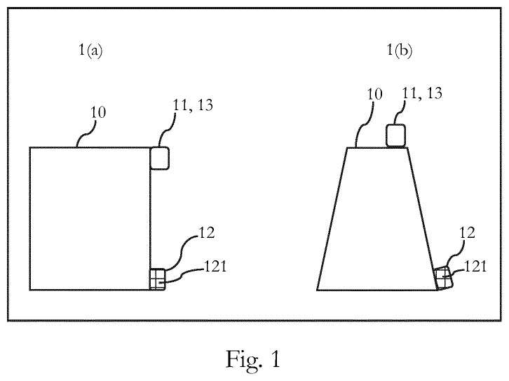

Before a detailed description of the embodiments under reference of FIG. 1 is given, general explanations are made.

As mentioned in the outset, generally it is known to “detect” objects and estimate their position information (e.g. distance), for example, by emitting a laser beam to an object and capturing an image from the object, based on the light reflected by the object, and estimating the distance between the object and the camera, or the like, based on the roundtrip time of the emitted light. The object itself might not be detected, but detecting an object is to be understood broadly in the sense that an object is seen based on the reflected light. Hence, an object may be detected, for example, only by receiving reflected light, but without identifying any further characteristic of the object.

Moreover, in the existing devices such as conveyer belt scanners, the position of the camera and the laser should be precisely fixed, for example, both devices should be installed on a deformable sturdy plate, in order to have a fixed distance between the light capturing sensor, e.g. camera, and the light emitting element, e.g. laser.

As mentioned in the outset, the existing techniques are further limited to deliver a basic position information of the objects, e.g. distance to the object, angle, or the like, and for example, cannot always determine with enough precision and accuracy three-dimensional (3D) shapes of objects, etc.

Also, in the cases where the position information of the objects are estimated, it is necessary to consider for example, effects of the ambient light, shape of the objects, movement of the objects, etc.

Consequently, some embodiments pertain to an apparatus including a light emitting unit configured to emit a sheet of light for illuminating an object, and a detection source, configured to estimate first position information of the object, based on time of flight detection of light reflected by the object; and detect light reflected by the object for determining second position information of the object, wherein the second position information of the object is determined based on triangulation, and wherein the triangulation is based on the estimated first position information.

The apparatus may be any type of electronic device, which has one or more detection sources. For example, the apparatus may be or may include an advanced driver-assistance system which is configured to assist a driver in the driving process of a vehicle and may be designed with a human-machine interface, or the like.

The apparatus may be or may include an intelligent parking assist system, an autopilot system, a driver monitoring system, a vehicular communication system, an imaging system, a (piece of) detection equipment, a (piece of) inspection equipment e.g., an airport inspection facility, a parcel inspection facility, etc., a computer, a robot, or the like.

In some embodiment, the apparatus may further be incorporated, in other devices such as a vehicle, e.g. an automobile, a motorcycle, a truck, a bus, etc.

The apparatus includes a light emitting unit. The light emitting unit may be based on a light emitting diode (LED), a laser light, a high intensity discharge (HID), e.g. a xenon lamp, etc., without limiting the present disclosure in that regard.

In some embodiments, the light emitting unit may include at least one (or more) light emitting element (s), e.g., a laser element, a light emitting diode, or the like. Moreover, the light emitting unit may further be configured to emit the sheet of light for illuminating the object. The sheet of light may be based on one light ray which is (timely) distributed in one plane, thereby producing the sheet of light. The sheet of light may also be generated based on multiple light rays which are emitted in parallel in one plane. Also, a mixture of both technologies may be used. There is no specific limitation in producing the sheet of light.

In some embodiments, the light emitting unit includes an array, including multiple light emitting elements, such as laser elements (e.g. multiple vertical-cavity surface emitting lasers) or LED elements. The light emitting unit may generate multiple parallel light rays which are in the same plane, and by controlling distances between the multiple light emitting elements, the light rays may be “connected” to each other, and a sheet of light may be emitted, for illuminating the object. Furthermore, the object may reflect the light, and the light reflected by the object may be detected and its position information may be determined.

The detection source may include one or more detectors, and may further be configured to detect light reflected by the object and estimate its position information, etc.

Hence, in some embodiments, the detection source may include, e.g., a first detector and a second detector. Moreover, the first detector and the second detector may be included in one housing, and for example, may further be combined to form the (single) detection source, etc. For instance, the first detector may be based on a time of flight sensor and the second detector may be based on a complementary metal-oxide-semiconductor (CMOS) image sensor. Moreover, the time of flight sensor may be combined with the CMOS image sensor disposed on a common silicon substrate, hence, the first detector and the second detector may be for example, located in one housing, combined, or the like.

In some embodiments, the detection source may be based on a complementary metal-oxide-semiconductor (CMOS) sensor. Moreover, the CMOS sensor may further be configured to deliver an improved light collection efficiency, e.g., by optimizing the pixel construction, etc., and may enable high-speed distance measurement processing.

In some embodiments, the CMOS image sensor and the time-of-flight (TOF) sensor may be based on an identical CMOS sensor which are combined together. Hence, in some embodiments, the image sensor and the time-of-flight (TOF) sensor share a common CMOS image sensor.

The present disclosure is not limited to the specific example of a CMOS image sensor, and in other embodiments, the detection source may include an image detector or image element which is shared for time-of-flight measurement and for detection of reflected light for determining second position information.

In some embodiments, the detection source may include multiple detectors which are assembled on a common substrate. Moreover, for example, the multiple detectors may include a first detector which may be based on a time of flight sensor, and a second detector, which may be based on an (or another type of) image sensor. Furthermore, both the TOF sensor and the image sensor may be configured to capture images of the same scene, simultaneously, etc.

In some embodiments, the detection source which may be based, for example, on the CMOS sensor, may further be configured to extract a TOF signal, e.g., by subtracting images without light signal. For instance, in some embodiments, the three-dimensional (3D) TOF sensor may be based on a Current Assisted Photonic Demodulator (CAPD) pixel, and may further be configured to subtract images, i.e. to measure the difference between a picture of the scene, with and without an active illumination.

In some embodiments, a High Dynamic Range (HDR) CMOS sensor may be used. Moreover, the HDR CMOS sensor may capture two separate pictures, may read each of them out, and may further subtract them in memory. For instance, the 3D-TOF sensor may include two accumulation nodes in each pixel, in which one of them is used for an image with illumination, and the other accumulation node is used for an image without illumination. Moreover, the 3D-TOF sensor may be configured to read-out each of the pixels, and perform a subtraction and read-out the difference, e.g., instantly, etc.

In the following, the terms, “first detector” and “second detector” are used, which refer to the first detection method which is based on the time of flight sensor and the second detection method which refers to the image sensor, without limiting the present disclosure in that regard, e.g., to a specific number of detection sources or specific number of detectors and to the physical relationship between detection sources or detectors, e.g., whether and how they are combined on one substrate, being included in one housing, being based on an identical CMOS sensor, etc.

Moreover, although in the following it is also referred to “first detector” and “second detector”, the following explanations also apply to embodiments where the detection source only includes one detector, e.g. CMOS sensor or the like, and in such embodiments, the detection source is used or has the function as a first detector and as a second detector, respectively.

In some embodiments, there might be a predefined distance between the first detector and the second detector, without limiting the present disclosure in that regard.

As discussed, in some embodiments, the apparatus includes the detection source which may be configured to estimate first position information of the object, based on time of flight detection of light reflected by the object. For example, the detection source may include a time of flight (TOF) sensor (which may be the first detector). The time of flight sensor may be based on, a continuous wave time of flight (CWTOF), a direct time-of-flight imager, an RF-modulated light source, a range gated imager sensor, etc., without limiting the present disclosure in that regard. The time-of-flight sensor may include a range imaging camera, as it is generally known, which may be based on charge-coupled device (CCD) technology, complementary metal oxide semiconductor (CMOS) technology, or the like. The time-of-flight sensor may include an array of pixels, wherein each pixel includes one or more light detection elements.

Moreover, the detection source (its time of flight sensor) may estimate first position information of the object, based on time of flight detection of light reflected by the object.

For example, the time of flight sensor may measure the time which the light has taken to travel from the light emitting unit to the object and its reflection to the time of flight sensor, or another roundtrip delay which is indicative of the first position information of the object.

In some embodiments, the time of flight image sensors may detect position information (e.g. distance) for every pixel, and may further perform a 3D time of flight measurement, determine a depth map of the object, or the like.

The apparatus further includes the second detector in some embodiments (or the detection source function as second detector). Moreover, the apparatus, its circuitry and/or the detection source (or second detector) may further determine the second position information of the object, wherein the second position information of the object is determined based on triangulation and wherein the triangulation is based on the estimated first position information. Moreover, for example, the triangulation calculation may be performed by a program which runs on the circuitry of the apparatus, as it is generally known to the skilled person.

As discussed, the triangulation calculation is used, and the second position information of the object may be determined. For instance, the light emitting unit, which may be also included in the detection source (or may be included in the second detector), emits a light ray and illuminates the object. The light reflected by the object is detected by the detection source (e.g. second detector or shared image sensor or the like), which includes the image sensor. Furthermore, the detection source (e.g. second detector) may be displaced compared to the light emitting unit and the light reflected by the object may be detected.

Moreover, the light emitting unit, the detection source (or e.g. the second detector), and the illuminated part of the object, form a triangle, and by using the triangulation calculation, the second position information of the object (i.e. corresponding to the illuminated part of the object or the part reflected the light), may be determined.

The triangulation calculation which is generally known to the skilled person is used. For instance, by knowing the angle corresponding to light emitting unit and the angle corresponding to the detection source (e.g. second detector) in the triangle (e.g. in embodiments in which both angles are fixed), the position information of the objects, such as, the third angle corresponding to the object and the distances to the object may be estimated.

In some embodiments, the first position information (e.g. distance) estimated by the detection source (e.g. time of flight sensor) may be used, and the triangulation calculation may be based on the estimated first position information (e.g. first distance, angle, etc.). Moreover, the second position information (e.g. distance, angle, etc.) of the object may be determined based on the triangulation calculation. It is to be noted that the first/second position information is not limited to absolute position information, e.g. global positioning information, earth based coordinates, or the like, but that also any type of relative position information, e.g. between the apparatus and the object is meant. The position information may also cover one-dimensional, two-dimensional, three-dimensional information, etc.

For instance, the detection source (e.g. the detection source functioning as first detector or the first detector) of the apparatus estimates first position information of the object. The first position information is estimated by the time of flight detection of light reflected by the object and the distance between the time of flight sensor (and/or the apparatus) and the object may be estimated. Moreover, the estimated first position of the object (e.g. the distance) may be used for the triangulation calculation and the second position information of the object may be determined.

In some embodiments, the triangulation calculation may be performed, for example, based on two captured images in which one of them is captured with an active illumination, and the other image is captured without illumination. Moreover, the apparatus, its circuitry or its detection source may further be configured to perform a subtraction of two images, etc., as it is generally known to the skilled person in the field of image processing.

The object may be any object that reflects light and can be thereby detected, e.g. only based on the fact that it reflects light. For example, the object may be a physical substance, e.g. a vehicle, concrete, asphalt, a part of a road, a (piece of) road debris, a wall, a stone, a road sign, different types of nails and screws, construction supplies, etc., may be living (organic) species such as a human (a driver, a pedestrian, etc.), a tree, an animal, water, oil, mud, etc.

The object (or its surface) may reflect the light, and hence, the object may be detected. The reflected light may be any type of reflection that can be detected by the detection source. For example, the reflected light may be a normal reflection in which the angle of incident and the angle of reflection are equal. Moreover, the object may reflect the light based on a specular reflection and/or a diffuse reflection and/or a scattering reflection, or the like. Likewise, the detection source (e.g. the time of flight image sensor of the first detector and/or the CMOS image sensor of the second detector) may detect the light reflected by the object, and therefore, the object may be detected, or the like.

As indicated above, in some embodiments, due to having two sources for detecting position information, a deviation of a distance between the detection source (e.g. second detector) and the light emitting unit, can be compensated based on the first position information and the triangulation calculation. Thereby, for example, a larger distance between the light emitting unit and the detection source (e.g. second detector) may be provided and the distance variations between the light emitting unit and the detection source (e.g. second detector) may be compensated based on the first position information, since, for example, the distance variation does not influence the first position information.

In some embodiments, the first detector and the second detector or the detection source functioning as first detector and as second detector may have different measurement accuracies. For example, in some embodiments the second detector may have a higher measurement accuracy than the first detector. Hence, the first position information (distance) may only be used for calibrating the second detector and/or for compensating variations in the distances between the second detector and the light emitting unit. This compensation can be done, since by having the first and the second position information, based on different and independent detectors, the equation system for triangulation is over-determined. For instance, thereby, a deviation (error) in the distance between the second detector and the light emitting unit and/or a deviation in the angle between the second detector and the light emitting unit can be determined such that the accuracy of the second position information may be considerably be improved.

In some embodiments, the determined second position information and/or the image sensor of the second detector are also used by the first detector.

In some embodiments, the first and second position information may be determined in parallel, while in other embodiments, the first and second position information may be determined consecutively.

In some embodiments, the first position information may represent a distance between the time of flight sensor and the object. Moreover, the time of flight sensor may be configured to estimate the distance, or the like.

For instance, the time of flight sensor may calculate the time difference or phase difference to all points in a scene. Moreover, the distances to the different points of the scene may be derived from the time differences, and the distance between the object and the time of flight sensor may be estimated.

In some embodiments, the first position information may represent a tilt angle of the light emitting unit and/or the detection source (e.g. also the first detector and/or the second detector). Moreover, in some embodiments, the tilt angles may also change. For example, in some embodiments the apparatus may be incorporated in a vehicle and the tilt angles may change due to e.g., vibrations of the vehicle, different loadings of the vehicle (more or fewer passengers in different situations), permanent deformation, etc. Hence, in some embodiments, the tilt angles of e.g., the light emitting unit, the detection source (e.g. the first detector, and the second detector) may be estimated as the first position information. Moreover, the estimated tilt angles may be used for determining the second position information by the triangulation calculation.

In some embodiments, the detection source (e.g. second detector) is based on an image sensor. The image sensor may be e.g., a complementary metal-oxide-semiconductor (CMOS) sensor, a charge-coupled device (CCD) sensor, a camera, etc., without limiting the present disclosure in that regard.

Moreover, the second detector may be a high-dynamic range camera (based on the image sensor) with a plurality of pixels and may further be configured to enable a pixel level subtraction. Therefore, a differential image may be obtained, as known to the skilled person.

In some embodiments, the light emitting unit may further be configured to emit the sheet of light, such that light reflected by the object is at least partially in the field of view of the detection source (e.g. second detector).

The light emitting unit and the detection source (e.g. second detector) may be placed on a shared plate or in different plates, they may be installed next to each other, or they may be installed in such a way that there is a predefined distance between them. Moreover, for example, the tilt angles of e.g., the detection source (e.g. first detector, the second detector) and the light emitting unit may be controlled, and the light reflected by the object may be positioned in the field of view of the detection source, etc.

The apparatus may further include a circuitry. The circuitry may include one or more processor, one or more microprocessors, dedicated circuits, logic circuits, a memory (RAM; ROM, or the like), a storage, output means (display (e.g. liquid crystal, (organic) light emitting diode, etc.)), loud speaker, an interface (e.g. touch screen, a wireless interface such as Bluetooth, infrared, etc.), etc., as it is generally known.

In some embodiments, the light emitting unit may be configured to emit the sheet of light in a predefined direction.

The predefined direction may be, for example, the field of view of the detection source (of the first detector, the field of view of the second detector), the direction of a path of vehicle on which the apparatus is mounted, etc.

As discussed, in some embodiments, the light emitting unit, the detection source (e.g. first detector and the second detector) may be installed on a mobile apparatus such as a vehicle. Moreover, the light emitting unit may further be configured to emit the sheet of light in the direction of the path of vehicle.

Furthermore, the objects located on the path of vehicle, may be detected, and their position information may be determined Likewise, the movement of the vehicle (and accordingly, the movement of the apparatus) may illuminate different parts of the objects that are on the path of vehicle, e.g. other vehicles and drivers, road, road debris, possible pedestrians, animals, etc. Hence, different parts of the objects may reflect light, may be detected, and the position information of the different parts of the objects, and consequently their 3D shape, or parts of their 3D shape may be determined, e.g. by a program running on the circuitry of the apparatus and by using the triangulation calculation, as discussed above.

In some embodiments, the sheet of light includes a plurality of light rays in a plane.

As discussed above, the light emitting unit may include multiple light emitting elements. The multiple light emitting elements generate the plurality of light rays. Moreover, by adjusting for example, the distances between the multiple light emitting elements, e.g. arranging all elements in a row with a predefined distance from each other, the sheet of light may be emitted which may include the plurality of light rays in the plane, or the like.

In some embodiments, the ambient light may interfere with e.g., the emitted sheet of light, the reflected light by the object, etc. Furthermore, the apparatus, the circuitry and/or the light emitting unit, may further be configured to turn on and off, the emitted sheet of light. Moreover, the detection source (e.g. first detector and/or the second detector) may be configured to detect the reflected light by the object, accordingly. For example, the detection source (e.g. the second detector) which may be based on the image sensor, captures a first image of the object when the light emitting unit is turned on, and may further capture a second image of the object when the light emitting unit is turned off. The detection source (e.g. the second detector) may further subtract the second image from the first image, may further eliminate the effects of ambient light, may perform a post processing of the image, etc.

In some embodiments, the predefined distance between the multiple light emitting units may be adjusted, and instead of emitting the sheet of light, a plurality of light dots may be emitted. Moreover, the plurality of light dots may be focused (e.g. by using an optical lens), and the object may be illuminated by the plurality of dots which may have a higher local intensity. Hence, in some embodiments, the signal to noise ratio may be improved, etc.

In some embodiments, the light emitting unit may further be configured to emit a plurality of sheets of light.

For instance, the light emitting unit may include multiple light emitting elements. The multiple light emitting elements may be controlled in multiple rows, and each row may emit one sheet of light, hence, the plurality of sheets of light may be emitted.

In some embodiments, at least two sheets of light are emitted at two different directions.

In some embodiments, the multiple light emitting units may be controlled in different rows in which each row emits its corresponding sheet of light in a different direction, hence, the plurality of sheets of light may be emitted in different directions. Moreover, the circuitry of the apparatus may be configured to control the direction of the plurality of sheets of light, or the like.

In some embodiments, the multiple light emitting units may be installed on a holder such as a vehicle bulb holder, and the holder may be configured to, for example, turn to different directions, such as, upward, backward, left, and right, hence, the plurality of sheets of light may be emitted in different directions.

Moreover, the plurality of sheets of light may be illuminated for example, subsequently, simultaneously, etc.

In some embodiments, the circuitry of the apparatus may further be configured to determine a shape of the object, based on the detection of light reflected by the object.

In some embodiments, it is possible to determine position information (e.g. 3D information) of the moving objects, by illuminating, for example, subsequent sheets of light in different directions. Moreover, the plurality of sheets of light may illuminate different zones, and the detection source (e.g. the first detector and/or the second detector) may detect the reflected light by the object, as discussed above. Furthermore, the apparatus may determine the 3D information of the objects e.g. by 3D time of flight measurement, by triangulation calculation, etc.

For example, in some embodiments, multiple images corresponding to different parts of the object may be captured. Moreover, the triangulation calculation may be performed, and the distances (i.e. position information) of the different parts of the object, with respect to the apparatus may be determined. The determined position information of the different parts of the object may be used to estimate e.g. an overall shape of the object, parts of shape of the object, etc. Furthermore, the 3D position information of the object, 3D image of the object, and/or a depth information of the object may be determined.

Moreover, in some embodiments the detection source (e.g. first detector) may estimate a 3D depth map of the object. For example, the light emitting unit illuminates the object and/or a scene including the object. Moreover, a 3D time of flight detection of light reflected by the object may be performed, for example, by estimating the distance for every pixel in the time of flight sensor and generating a 3D depth map of the object and/or the scene.

In some embodiments, the plurality of sheets of light are emitted at a random time period.

In some embodiments, multiple apparatuses may emit the plurality of sheets of light, and a multi user environment may be created. For example, multiple vehicles in which, each vehicle includes its own apparatus may emit the plurality of sheets of light, and they might interfere together, which might, affect the differential images, generate cross-talk, or the like.

In some embodiments, a 3D time of flight measurement may be used together with a 3D triangulation calculation, moreover, a plurality of parameters such as distance, angle, 3D shape of the object, etc., may be determined. Additionally, a triangulation calculation may be performed by using the determined plurality of parameters which are determined by the detection source (e.g. first and/or the second detectors).

In some embodiments, in order to increase the accuracy of the triangulation calculation, the relative position of the detection source (e.g. second detector) with respect to the light emitting unit such as the distance between them, and their relative angles may be determined. Moreover, the parameters which define the relative positions of the detection source (e.g. second detector) with respect to the light emitting unit, such as, relative coordinates and relative angles may be for example, continuously determined, and updated. Moreover, for each parameter a triangulation calculation may be performed and the parameter which provides for example, the maximum correspondence between the 3D time of flight measurement and triangulation calculation and/or the parameter which provides the lowest error may be determined. For example, the 3D time of flight measurements and the triangulation calculations may be fitted with each other by e.g., using a least squares fitting, as it is generally known to the skilled person. Hence, in some embodiments, it is possible to determine and to update the parameter which provide highest accuracy and/or the best fitting between the 3D time of flight measurements and the triangulation calculations.

In some embodiments, the 3D time of flight measurements and the triangulation calculations may be performed simultaneously, subsequently, etc., without limiting the present disclosure on that regard.

For instance, in some embodiments, first a 3D time of flight measurements may be performed and then a triangulation calculation. In some embodiments, first a triangulation calculation may be performed and then a 3D time of flight measurements.

In some embodiments, a 3D time of flight measurement may be performed simultaneously with a triangulation calculation. Moreover, the first position information and the second position information may afterward be determined, e.g. by processing the 3D time of flight measurement and the triangulation calculations in, e.g., millisecond after the measurements, seconds after the measurements, hours after the measurements, etc., without limiting the present disclosure in that regard.

In some embodiments, the relative positioning parameter between the first detector and the second detector, e.g., relative distance between them, relative angles, etc., may be determined and the triangulation calculation may stem from the 3D time of flight measurement and/or the triangulation calculation, without limiting the present disclosure in that regard.

Hence, in some embodiments, it is possible to emit the plurality of sheets of light at a random time period and therefore, randomize the period between the moments in time that each zone of the object is illuminated. Moreover, the apparatus and/or its circuitry may be configured to detect the reflections of the light, which are emitted by the light emitting unit in the same apparatus. For example, the circuitry may determine a predefined time period for emitting the sheet of light and the detection source (e.g. second detector) may detect the reflected lights based on the predefined time period, or the like.

In some embodiments, there might be a short predefined distance between the detection source (e.g. second detector) and the light emitting unit (e.g. approximately 10 cm or shorter than 10 cm). Moreover, it may be possible to detect the reflected light from the object and to determine position information of the object.

In some embodiments, there might be a longer predefined distance between the detection source (e.g. second detector) and the light emitting unit (e.g. approximately 1 m or larger). Moreover, the position information of the objects that are located in the distance of approximately 20 m to 70 m from the apparatus, may be determined.

In some embodiments, the apparatus may be incorporated in a vehicle. The vehicle may be loaded in a different way, depending on time and situations, and the distance between the light emitting unit and the detection source (e.g. second detector), and their corresponding angles may change. Moreover, it may be possible to determine a position information of objects which are e.g. on the path of vehicle, even if the distance between the detection source (e.g. second detector) and the light emitting unit changes. For example, it may be possible to perform a calibration, e.g. by determining the first position information by the time of flight sensor, as discussed above and using the estimated first position for the triangulation calculation.

In some embodiments, a calibration of the triangulation calculation (and/or the detection source (e.g. second detector)) may be performed, and the calibration may be based on the estimated first position information. For example, the time of flight sensor estimates the first position information, and the distance between the apparatus and the object may be determined. Moreover, the determined distance may be used and the triangulation calculation may be calibrated, or the like.

In some embodiments, a plurality of time of flight measurements on different parts of the object may be performed, and for example, the noise from the time of flight measurements may be reduced or removed, the accuracy of the measurements may be increased, or the like.

In some embodiments, the object may be a moving object. Moreover, it may be possible to e.g. illuminate different parts of the object, detect light reflected from the different parts of the object, and determine position information of different parts of the object, or the like.

In some embodiments, the apparatus may be incorporated in a vehicle. Moreover, the apparatus and an object on the path of vehicle may move at the same speed (e.g. the object is another vehicle driving with the same speed). Additionally, it may be possible to determine the position information of the object. For example, the object may be illuminated by a plurality of sheets of light, in which at least two sheets of light are emitted in two different directions. Hence, different parts of the object may be illuminated, may reflect the light, and their position information may be determined.

In some embodiments, it may be possible to illuminate the object with the plurality of rays, and the rays may be controlled in such a way that the object may be illuminated by a dotted line, as discussed above. Moreover, the detection source (e.g. second detector) may be controlled to have a short exposure time, or the like, and the ambient light influence may be reduced.

In some embodiments, the predefined distance between the light emitting unit and the detection source (e.g. second detector) may increase to approximately one meter or greater than one meter. Moreover, the light emitting unit and the detection source (e.g. second detector) may be tilted, as discussed above, which may rise to a specific angle and distort the determination of the second position information. Hence, in some embodiments, it is possible to for example, modulate the light emitting unit and perform in parallel the first position estimations measurements. For example, a 3D time of flight measurements, may be performed in parallel with the second position information measurements and the apparatus may be thereby calibrated, or the like.

Some embodiments pertain to a method including estimating first position information of an object; emitting a sheet of light for illuminating the object; and detecting light reflected by the object for determining second position information of the object, wherein the second position information of the object is determined based on triangulation; and wherein the triangulation is based on the estimated first position information. The method may be performed by a circuitry and/or a program running on the circuitry as discussed herein, and/or a processor, a computer, a tablet pc, etc.

As discussed, the method may further include estimating first position information of the object, moreover, the first position information may represent a distance between the time of flight sensor and the object. As discussed, the method may further include emitting the sheet of light in a predefined direction. Moreover, a plurality of light rays may be generated, the method may further include a plurality of light rays in a plane. As discussed, the method may further include emitting a plurality of sheets of light. Moreover, the method may further include emitting at least two sheets of light at two different directions. As discussed, the method may further include emitting the plurality of sheets of light at a random time period. As discussed, the shape of the object may be determined, the method may further include determining the shape of the object, based on the detection of light reflected by the object. The method may further include detecting the light reflected by the object, wherein the detection source is based on an image sensor and a time-of-flight sensor. Moreover, the method may further include detecting the light reflected by the object, wherein the detection source is based on a complementary metal-oxide-semiconductor sensor.

The methods as described herein are also implemented in some embodiments as a computer program causing a computer and/or a processor to perform the method, when being carried out on the computer and/or processor. In some embodiments, also a non-transitory computer-readable recording medium is provided that stores therein a computer program product, which, when executed by a processor, such as the processor described above, causes the methods described herein to be performed.

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Returning to FIGS. 1(a) and 1(b), there is illustrated a first embodiment of an apparatus 10 for detecting objects and determining their position information.

FIG. 1(a) illustrates the apparatus 10 from a front view and FIG. 1(b) illustrates a top view of the apparatus 10 according to the present disclosure.

The apparatus 10 has a first detector 11 which includes (and hereinafter, may be referred to) a time of flight sensor.

Moreover, the apparatus 10 has a light emitting unit 12, which is based on the laser light. The light emitting unit 12 has multiple controllable laser light emitting elements 121 which are placed on several rows, and enable the light emitting unit 12, to emit, for example, a sheet of light, a plurality of light rays forming a sheet of light, a plurality of sheets of light, or the like. Moreover, the light emitting unit 12 and its multiple light emitting elements can be controlled and, hence, the direction of, e.g., the emitted sheet of light, can be controlled.

The apparatus 10 also has a second detector 13 which is based on an image sensor. As can be taken from FIG. 1(b), in the present embodiment, the second detector 13 and the light emitting unit 12 are placed on two different plates, with a predefined distance from each other, without limiting the present disclosure in that regard, wherein, as discussed, this predefined distance may vary due to environmental influences, e.g. temperature, forces acting on structural elements and the like. Moreover, in the present embodiment, the first detector 11 and the second detector 13 are located in one housing, and forming a detection source.

The first detector 11, the light emitting unit 12 and the second detector 13 are connected to each other and form a circuitry. The apparatus 10 of FIGS. 1(a) and 1(b) is discussed in more detail further below.

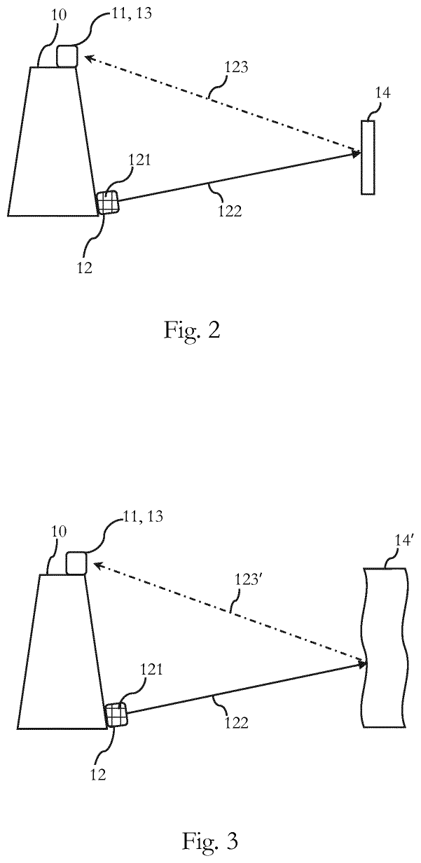

As depicted in FIG. 2, the light emitting unit 12 of the apparatus 10 emits a light ray 122 with one of its light emitting elements 121 and illuminates an object 14 which has regular surfaces. The object 14 reflects the light and the reflected ray of light 123 of the object 14 is in the field of view of the first detector 11, and the second detector 13 which includes (and hereinafter, may be referred to) the image sensor, as discussed above. The reflected ray of light 123 is detected by the time of flight sensor of the first detector 11 and the image sensor of the second detector 13.

Moreover, the light emitting unit 12, the second detector 13 and the illuminated part of the object 14 form a triangle, as discussed above.

The time of flight sensor 11 of the apparatus 10 is based on the time-of-flight imager and includes the range imaging camera. Moreover, the time-of-flight sensor 11 has an array of pixels in which each pixel has multiple light detection elements. The time of flight sensor 11 of the apparatus 10 measures the time which the light has taken to travel from the light emitting unit 12 to the object 14 and its reflection to the time of flight sensor 11 and estimates the first position information of the object 14, in which in the present embodiment is the distance between the time of flight sensor 11 and the object 14.

FIG. 3 illustrates an embodiment of the apparatus 10 for detecting an object 14′ and determining its position information. The object 14′ is an irregular object, in which two of its surfaces have irregular shapes. As discussed above, there is no limitation on detecting different types of objects. Every object that reflects light and the reflected light is in the field of view of the first detector 11 and/or the second detector 13, can be detected.

The light emitting unit 12 of the apparatus 10 emits the light ray 122 with one of its light emitting elements 121 and illuminates one of the irregular surfaces of the object 14′. Part of the irregular surface of the object 14′ is illuminated and reflects a light 123′. The reflected light 123′ is detected by the time of flight sensor 11 and the image sensor 13. Moreover, the light emitting unit 12, the second detector 13, and the illuminated part of the object 14′ form a triangle.

The time of flight sensor 11 of the apparatus 10 measures a first position information of the object 14′, which is a distance between the time of flight sensor 11 and the object 14′.

Furthermore, the estimated distance between the time of flight sensor 11 and the object 14′, is used for the triangulation calculation, which is performed by the circuitry of the apparatus. The triangulation calculation is generally known to the skilled person. As discussed above, the distance between the time of flight sensor 11 and the object 14′ can be used for the triangulation calculation, and for example, the distance between the second detector 13 and the object 14′ can be estimated.

Similarly, the distance between the time of flight sensor 11 and the object 14′ can be used and the distances between the light emitting unit 12 and/or the apparatus 10 with the object 14′, and/or the angles corresponding to the light emitting unit 12 and the second detector 13 can be estimated based on the triangulation calculation, as known to the skilled person.

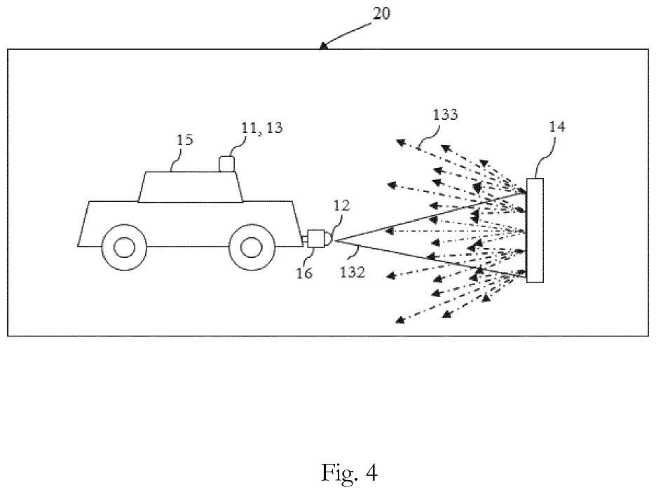

FIG. 4 illustrates a system 20 including a first embodiment of the apparatus 10 incorporated in a vehicle 15. Moreover, the light emitting unit 12 is installed on a holder 16 which is based in the present embodiment on a vehicle bulb holder 16. The light emitting unit 12 emits a sheet of light 132 in the direction of the path of vehicle 15, and the object 14 which is located on the path of the vehicle 15 reflects the light. The light reflected by the object 133 is in the field of view of the second detector 13 (which is based on the image sensor in this embodiment) and the object 14 is detected.

Furthermore, the vehicle 15 is moving, and its movement illuminates different parts of the object 14. Therefore, the positions of the different parts of the object 14, which reflect the light 133, can be determined.

As discussed above, the time of flight sensor 11 determines the first position information of the object 14, which is the distance between the time of flight sensor 11 and the object 14. Moreover, the estimated distance (i.e. estimated by the time of flight sensor 11) is used for triangulation calculation and the second position information of the object 14 is determined.

In the present embodiment, the distance between e.g. the vehicle 15 (i.e. different parts of the vehicle) and the object 14, the light emitting unit 12 and the object 14, the second detector 13 and the object 14, or the like, are determined based on the triangulation calculation, as it is generally known to the skilled person.

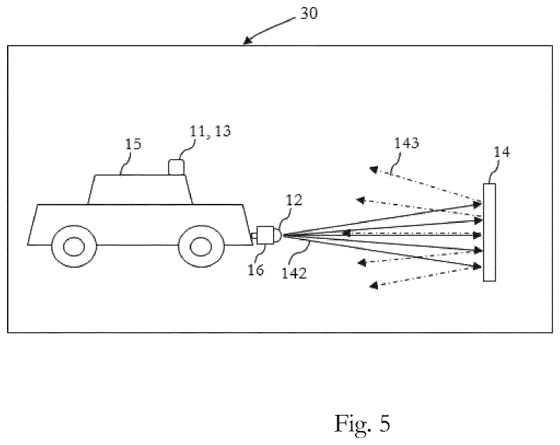

FIG. 5 illustrates a system 30 including the second embodiment of the apparatus 10 incorporated in the vehicle 15. Moreover, the light emitting unit 12 includes multiple light emitting elements, and emits a plurality of light rays 142 on the path of the vehicle 15, as discussed above.

In the present embodiment, the multiple light emitting elements are placed in a row and the plurality of light rays 142 are in a plane. Moreover, the distances between the multiple light emitting elements are adjusted in such a way that a plurality of dots are illuminated on the object 14, as discussed above.

Moreover, the circuitry of the apparatus (not shown) is able to control, and to turn on and off the plurality of light rays 142.

The object 14 reflects the light and part of the reflected plurality of light rays 143 are detected by the second detector 13.

The second detector 13 which is based on the image sensor, captures a first image of the object 14 when the light emitting unit is turned on and then captures a second image of the object 14 when the light emitting unit is turned off. Moreover, the second detector 13 subtracts the second image from the first image, and eliminates the effects of ambient light, as discussed above.

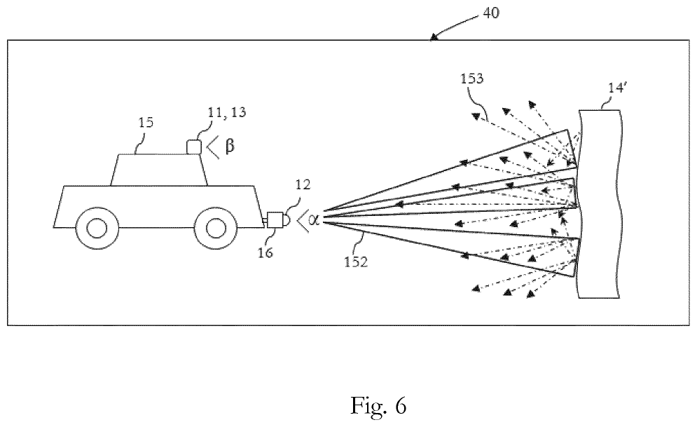

FIG. 6 illustrates an embodiment of a system 40 including a third embodiment of the apparatus 10 which is incorporated in the vehicle 15.

The light emitting unit 12 of the apparatus includes multiple light emitting elements which are controlled in multiple rows, and each row emits one sheet of light, as discussed above. Hence, the circuitry of the apparatus is able to control the emitting of a sheet of light, a ray of light, a plurality of light rays, a plurality of sheets of light, or the like, as discussed above.

Moreover, the circuitry is also able to control the direction of e.g. the different sheets of light, the time period between the moment that each sheet of light is emitted, etc., as discussed above.

Additionally, the light emitting unit 12 and the second detector 13 can be tilted with the angles of α and β, correspondingly, as discussed above.

In the present embodiment, the light emitting unit emits a plurality of sheets of light 152, in which the plurality of sheets of light 152 are emitted in different directions.

Moreover, the plurality of sheets of light 152 are emitted, subsequently, and illuminate different parts of the object 14′ which has irregular surfaces, as discussed above.

The object 14′ reflects the light. The light reflected by the object 153 is in the area of field of view of the first detector 11 and the second detector 13 which is based on the image sensor, as discussed above.

Moreover, the plurality of sheets of light 152 are illuminated, subsequently, and in different direction. Therefore, the different parts of the object 14′, are subsequently illuminated.

The time of flight sensor 11 estimates first position information of the different parts of the object 14′, and determines the distances of the different parts of the object 14′ to the time of flight sensor 11, to the vehicle 15, to the second detector 13, etc. The determined distances of the different parts of the object 14′ are used for triangulation calculation, as discussed above, and the second position information of the different parts of the object 14′, are determined.

Moreover, the circuitry of the apparatus determines the 3D shape of the object 14′. The 3D shape of the object 14′ is determined based on the triangulation calculation for different parts of the object 14′, as discussed above.

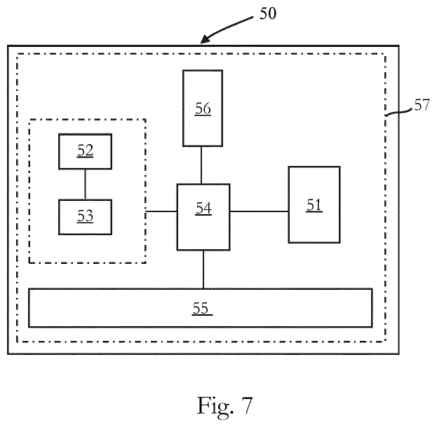

FIG. 7 illustrates an embodiment of the apparatus 50, including a circuitry 57, for detecting an object and determining its position information;

The apparatus 50 of FIG. 7 has the same or similar structural elements and the same or similar function as the apparatus 10 of FIGS. 1 to 6.

The apparatus 50 has a light emitting unit 51, a first detector 52 including a time of flight sensor, and a second detector 53. The light emitting unit 51 is based on LED or LASER light, and the second detector 53 is based on an image sensor.

Moreover, the apparatus 50 has a processor 54, a storage 55, and an interface 56, which form a circuitry 57.

The storage 55 includes a random access memory and a solid-state drive memory.

The interface is based on a human-machine interface, a human can provide information to the circuitry, and the interface is further able to provide access to a local area network (LAN) and the circuitry 57 can be connected to internet, or the like.

The processor 54 of the apparatus 50 is able to run a computer program. For example, a computer program may run on the processor 54 of the apparatus 50 which can control emitting the plurality of sheets of light, the direction of the plurality of sheets of light, the time period between the emitted plurality of sheets of light, or the like.

Moreover, several programs can run on the processor of 54 of the apparatus 50 which can, for example, run the triangulation calculation, estimate first position information of the object, determine 3D shape of the object, or the like, as known to the skilled person.

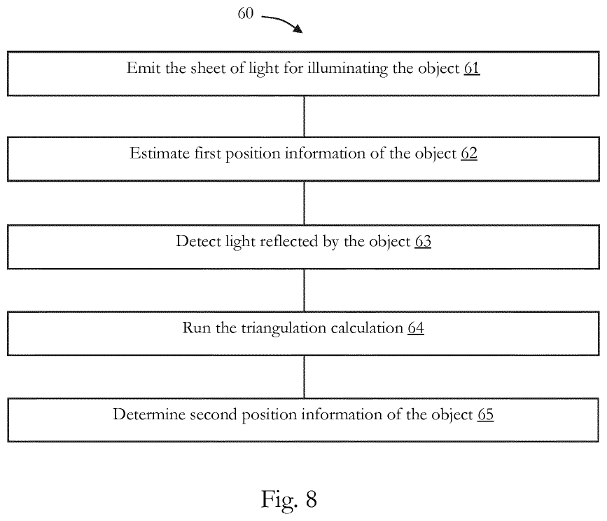

In the following, a method 60 for detecting an object and determining its position information, is explained under the reference of FIG. 8. The method may be performed by and with any of the apparatuses described herein, such as the apparatus 10 of FIGS. 1 to 6 and the apparatus 50 of FIG. 7. Without limiting the disclosure, in the following the method 60 is discussed exemplary based on the apparatus 50 which is similar to apparatus 10.

At 61, the circuitry 57 controls the light emitting unit 51 to emit the sheet of light 142 and illuminate the object 14. The light emitting unit emits the sheet of light 142, as discussed above, the sheet of light 142 has the plurality of light rays which are in the same plane, as discussed above.

At 62, the circuitry 57 of the apparatus 50 (or apparatus 10) estimates the first position information of the object.

The time of flight sensor in the first detector 52, which is based on the time of flight imager, measures the time which the light has taken to travel from the light emitting unit 51 to the object 14 and back to the time of flight sensor 52. Moreover, for example, a program running on the processor 54 of the circuitry 57 estimates the first position information, which is the distance between the time of flight sensor 52 and the object 14.

At 63, the circuitry 57 controls the second detector 53 to detect the reflected light by, for example, the object 14.

The second detector 53, which is based on the image sensor, detects parts of the reflected light (for example, the plurality of light rays 143) which are in the field of view of the second detector 53.

At 64, the circuitry 57 runs the triangulation calculation. A program running on the processor 54 of the circuitry 57 runs the triangulation calculation. The program uses the estimated first position information for the triangulation calculation. The results of the triangulation calculations are the values of three angles (in the triangle of light emitting unit, second detector and object) and three sides of the triangle. The triangulation calculation is generally known to the skilled person, as discussed above.

At 65, the circuitry 57 determines a second position information of the object 14. A program running on the processor 54 of the circuitry 57 determines the second position information of the object. The program determines the distance between the part of the object which is illuminated and reflected the light and the apparatus 50, as discussed above.

Hence, the object 14 is detected and its distance to the apparatus is determined.

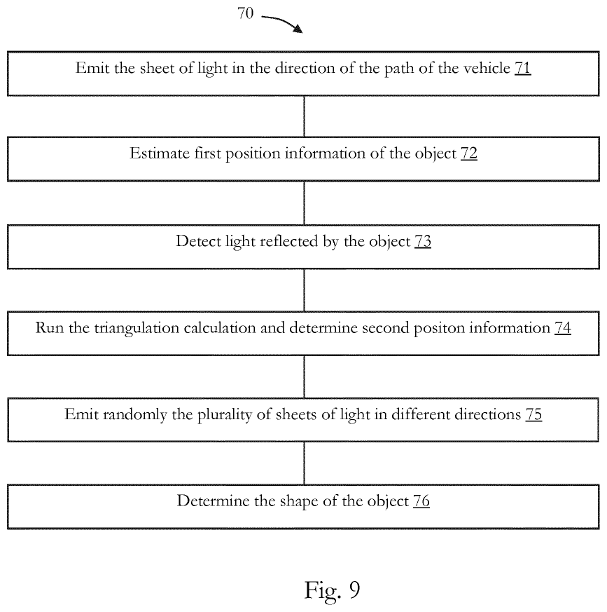

FIG. 9 illustrates an embodiment of a method 70 for detecting the object 14′ and determining its 3D shape.

At 71, the circuitry 57 controls the light emitting unit 51 to emit a plurality of sheets of light (for example, the plurality of sheets of light of 152) in the direction of the path of the vehicle 15 and to illuminate the object 14′.

The light emitting unit 51 emits the plurality of sheets of light 152 and illuminates the object 14′ which is in the path of the vehicle 15.

At 72, the circuitry 57 of the apparatus 50 (or apparatus 10) estimates the first position information of the object 14′.

The time of flight sensor in the first detector 52 measures the time which the light has taken to travel from the light emitting unit 51 to the object 14′, and its reflection to the time of flight sensor 52. Moreover, a program running on the processor 54 of the circuitry 57 estimates a first position information, which is the distance between the time of flight sensor 52 and the object 14′.

At 73, the circuitry 57 controls the second detector 53 to detect the light reflected by the object 14′. The second detector 53, which is based on the image sensor, detects parts of the reflected light 153 which are in the field of view of the second detector 53.

At 74, the circuitry 57 runs the triangulation calculation. A program running on the processor 54 of the circuitry 57 runs the triangulation calculation.

The running program on the processor 54 uses the estimated first position information for the triangulation calculation. Moreover, the circuitry 57 determines a second position information of the part of the object 14′ which reflected the light.

The second position information is determined for different parts of the object. In the present embodiment, the distance and the angles for different parts of the object are determined, as discussed above.

At 75, the circuitry 57 emit randomly the plurality of sheets of light 152 in different directions.

The circuitry 57 controls the light emitting unit 51 to emit the plurality of sheets of light 152 in different directions. Hence, different parts of the object 14′ are illuminated. Moreover, the circuitry 57 controls the light emitting unit 51 to randomize the time period in which different sheets of light are emitted.

At 76, the circuitry determines a shape of the object 14′.

Different parts of the object 14′ are illuminated and reflect the light. The reflected light is detected by the second detector 53. Moreover, the circuitry 57 runs the triangulation calculation for each point of the objects which reflected the light. The program running on the processor 54 uses the estimated first position information for the triangulation calculation and the circuitry 57 determines the second position information for different parts of the object.

Furthermore, a program running on the circuitry 57, for example, uses all determined second positions for different parts of the object 14′ and determines the 3D shape of the object 14′, as discussed above. For example, the program may connect the determined second positions for neighboring parts of the object that reflected the light, and the shape of the object may be determined, or the like.

It should be recognized that the embodiments describe methods with an exemplary ordering of method steps. The specific ordering of method steps is however given for illustrative purposes only and should not be construed as binding. For example, the ordering of 74 and 75 in the embodiment of FIG. 9 may be exchanged. Also, the ordering of 61, 62 and 63 in the embodiment of FIG. 8 may be exchanged. Further, also the ordering of 71 and 72 in the embodiment of FIG. 9 may be exchanged. Other changes of the ordering of method steps may be apparent to the skilled person.

Please note that the division of the circuitry 57 into units 51 to 56 is only made for illustration purposes and that the present disclosure is not limited to any specific division of functions in specific units. For instance, the circuitry 57 could be implemented by a respective programmed processor, field programmable gate array (FPGA) and the like.

The methods described herein can also be implemented as a computer program causing a computer and/or a processor and/or a circuitry, such as processor 54 discussed above, to perform the method, when being carried out on the computer and/or processor and/or the circuitry. In some embodiments, also a non-transitory computer-readable recording medium is provided that stores therein a computer program product, which, when executed by a processor, such as the processor described above, causes the method described to be performed.

In so far as the embodiments of the disclosure described above are implemented, at least in part, using software-controlled data processing apparatus, it will be appreciated that a computer program providing such software control and a transmission, storage or other medium by which such a computer program is provided are envisaged as aspects of the present disclosure.

Note that the present technology can also be configured as described below.

(1) An apparatus comprising:
a light emitting unit configured to emit a sheet of light for illuminating an object; and
a detection source, configured to
   estimate first position information of the object, based on time of flight detection of light reflected by the object; and
   detect light reflected by the object for determining second position information of the object, wherein the second position information of the object is determined based on triangulation, and wherein the triangulation is based on the estimated first position information.

(2) The apparatus of (1), wherein the first position information represents a distance between the time of flight sensor and the object.

(3) The apparatus of (1) or (2), wherein the light emitting unit is further configured to emit the sheet of light in a predefined direction.

(4) The apparatus of anyone of (1) to (3), wherein the sheet of light includes a plurality of light rays in a plane.

(5) The apparatus of anyone of (1) to (4), wherein the light emitting unit is further configured to emit a plurality of sheets of light.

(6) The apparatus of anyone of (1) to (5), wherein at least two sheets of light are emitted at two different directions.

(7) The apparatus of anyone of (1) to (6), wherein the plurality of sheets of light are emitted at a random time period.

(8) The apparatus of anyone of (1) to (7), further comprising a circuitry configured to determine a shape of the object, based on the detection of light reflected by the object.

(9) The apparatus of anyone of (1) to (8), wherein the detection source comprises an image sensor and a time-of-flight sensor.

(10) The apparatus of anyone of (1) to (9), wherein the detection source is based on a complementary metal-oxide-semiconductor sensor.

(11) A method comprising:
emitting a sheet of light for illuminating an object;
estimating first position information of the object; and
detecting light reflected by the object for determining second position information of the object, wherein the second position information of the object is determined based on triangulation, and wherein the triangulation is based on the estimated first position information.

(12) The method of (11), wherein the first position information represents a distance between the time of flight sensor and the object.

(13) The method of (11) or (12), further comprising emitting the sheet of light in a predefined direction.

(14) The method of anyone of (11) to (13), further comprising including a plurality of light rays in a plane.

(15) The method of anyone of (11) to (14), further comprising emitting a plurality of sheets of light.

(16) The method of anyone of (11) to (15), wherein at least two sheets of light are emitted at two different directions.

(17) The method of anyone of (11) to (16), wherein the plurality of sheets of light are emitted at a random time period.

(18) The method of anyone of (11) to (17), further comprising determining a shape of the object, based on the detection of light reflected by the object.

(19) The method of anyone of (11) to (18), wherein the detection source comprises an image sensor and a time-of-flight sensor.

(20) The method of anyone of (11) to (19), wherein the detection source is based on a complementary metal-oxide-semiconductor sensor.

(21) A computer program comprising program code causing a computer to perform the method according to anyone of (11) to (20), when being carried out on a computer.

(22) A non-transitory computer-readable recording medium that stores therein a computer program product which, when executed by a processor, causes the method according to anyone of (11) to (20) to be performed.

1. An apparatus comprising:
a light emitting unit configured to emit a sheet of light for illuminating an object; and
a detection source, configured to
estimate first position information of the object, based on time of flight detection of light reflected by the object; and
detect light reflected by the object for determining second position information of the object, wherein the second position information of the object is determined based on triangulation, and wherein the triangulation is based on the estimated first position information.

2. The apparatus of claim 1, wherein the first position information represents a distance between the time of flight sensor and the object.

3. The apparatus of claim 1, wherein the light emitting unit is further configured to emit the sheet of light in a predefined direction.

4. The apparatus of claim 1, wherein the sheet of light includes a plurality of light rays in a plane.

5. The apparatus of claim 1, wherein the light emitting unit is further configured to emit a plurality of sheets of light.

6. The apparatus of claim 5, wherein at least two sheets of light are emitted at two different directions.

7. The apparatus of claim 5, wherein the plurality of sheets of light are emitted at a random time period.

8. The apparatus of claim 1, further comprising a circuitry configured to determine a shape of the object, based on the detection of light reflected by the object.

9. The apparatus of claim 1, wherein the detection source comprises an image sensor and a time-of-flight sensor.

10. The apparatus of claim 1, wherein the detection source is based on a complementary metal-oxide-semiconductor sensor.

11. A method comprising:
emitting a sheet of light for illuminating an object;
estimating first position information of the object; and
detecting light reflected by the object for determining second position information of the object, wherein the second position information of the object is determined based on triangulation, and wherein the triangulation is based on the estimated first position information.

12. The method of claim 11, wherein the first position information represents a distance between the time of flight sensor and the object.

13. The method of claim 11, further comprising emitting the sheet of light in a predefined direction.

14. The method of claim 11, further comprising including a plurality of light rays in a plane.

15. The method of claim 11, further comprising emitting a plurality of sheets of light.

16. The method of claim 15, wherein at least two sheets of light are emitted at two different directions.

17. The method of claim 15, wherein the plurality of sheets of light are emitted at a random time period.

18. The method of claim 11, further comprising determining a shape of the object, based on the detection of light reflected by the object.

19. The method of claim 11, wherein the detection source comprises an image sensor and a time-of-flight sensor.

20. The method of claim 11, wherein the detection source is based on a complementary metal-oxide-semiconductor sensor.
